(19) United States
(12) Patent Application Publication
(10) Pub. No.: US 2014/0225332 A1
(43) Pub. Date: Aug. 14, 2014

(54) LUBRICATED SEAL WITH AXIAL LIP

(71) Applicant: Pieter Baart, Heiloo (NL)

(72) Inventor: Pieter Baart, Heiloo (NL)

(21) Appl. No.: 14/241,022

(22) PCT Filed: Aug. 9, 2012
(86) PCT No.: PCT/EP2012/065618

§ 371 Date: Apr. 9, 2014

(30) Foreign Application Priority Data
Aug. 25, 2011 (EP) PCT/EP2011/064604

(51) Int. Cl. F16J 15/16

(52) U.S. Cl. CPC F16J 15/162
USPC 277/549

(57) ABSTRACT

The present invention provides a rotary seal including a first part having an axial sealing lip and a second part having an axial counterface against which the axial sealing lip bears. According to the invention, a rotational one of the first part and the second part is provided with a reservoir for retaining a volume of grease at a location radially inward of the axial sealing lip. The reservoir is designed such that the movement of grease under the action of centrifugal force is prevented, while the movement of base oil, which bleeds from the volume of grease retained in the reservoir, is allowed. As a result, the supply of base oil to the sealing contact takes place for a longer period of time, which extends the life of the seal.

### TECHNICAL FIELD

The present invention relates to a rotary seal having at least one axial sealing lip that bears against an axially oriented counterface. More specifically, the invention relates to a grease-lubricated seal of this kind, whereby the seal is adapted for improved lubrication of a contact interface between the axial sealing lip and the counterface.

### BACKGROUND

An example of a rotary seal with an axial sealing lip is known from US 2010/0066030. This document describes a sealing device for a wheel bearing arrangement that is adapted for rotation of the bearing inner ring. The device comprises an elastomeric sealing element, mounted to a stationary part of the bearing arrangement, and a metal slinger, mounted to a rotational part of the bearing arrangement. The elastomeric element has a radial lip that bears against a cylindrical surface of the slinger and further has an axial lip that bears against a flange surface of the slinger. The primary function of the axial lip is to prevent the entry of contaminants into the bearing. A wheel bearing must operate in an environment where grit and moisture are heavily present, and the axial lip is therefore in tight contact with the flange surface of the slinger, to ensure that no ingress occurs. Under dynamic conditions, the resulting sliding contact generates friction and heat, meaning that lubrication is essential for preventing early failure of the seal.

In US 2010/0066030, a solution is proposed for improving the lubrication of the axial contact interface. The seal is provided with a grease lubricant and a non-contact part of the axial lip comprises a grease holding portion for holding grease that is to be supplied to a contact part of the lip. The grease holding portion may be provided in the form of concavities on the surface of the non-contact part, or annular or radial grooves.

Grease is a semi-solid substance that typically comprises a base oil that is held within a thickener matrix. Under hydrodynamic lubrication conditions, it is base oil from the grease that forms a lubricant film for preventing direct contact between the elastomeric lip and the metal counterface. When grease is supplied to a sliding contact interface, as taught by the above document, the grease will be sheared.

This shearing mechanism is one of the mechanisms by which base oil is released from grease, but it also has the effect of increasing frictional losses.

Consequently, there is room for improvement.

### DISCLOSURE OF THE INVENTION

The present invention is based on an improved understanding of grease lubrication in rotary seals.

In grease lubricated seals, the lubrication condition, or film thickness, is assumed to be determined by the availability of lubricant near the sealing contact. The present inventor has found that the available lubricant predominantly stems from grease that is present on a rotating part of the seal. Over time, the grease on the rotating part loses its base oil and eventually becomes incapable of providing an oil film thickness that adequately separates the sealing contact. The time at which this inadequate film thickness occurs can therefore be extended by increasing the amount of grease on the rotating part of the seal.

Thus, the present invention resides in a rotary seal comprising a first part having an axial sealing lip and a second part having an axial counterface against which the axial sealing lip bears, whereby one of the first and second parts is rotational with respect to the other of the first and second parts. According to the invention, the rotational part is provided with a reservoir for retaining a volume of grease at a location radially inward of the axial sealing lip. The reservoir is designed such that the movement of grease under the action of centrifugal force is prevented, while the movement of base oil, which bleeds from the volume of grease retained in the reservoir, is allowed. As a result, the supply of base oil to the sealing contact takes place for a longer period of time, which extends the life of the seal.

In a first embodiment of the invention, the second part of the seal is rotational. The second part may be a slinger comprising a cylindrical part and a radial flange part.

In one example, the reservoir is formed by a bend in the flange part, which creates a retention surface for retaining the volume of grease in a radial direction. Suitably, the retention surface extends in an axial direction at an angle of less than 40 degrees relative to a rotation axis of the seal. The angle of the retention surface may be adapted depending on the operating speed of the rotational part (i.e. the magnitude of the centrifugal force acting on the grease volume). For example, in low-speed applications, an angle of between 20 and 40 degrees may be used. In high-speed applications, an angle of less than 20 degrees is preferable. As a result, an axial component of the centrifugal force acting on the volume of grease is insufficient to cause sideways movement of the grease, but is sufficient to allow side-flow of base oil. In some applications, to prevent movement of the grease, the retention surface may be parallel to the axis of rotation, so that the axial component of the centrifugal force is zero. In such applications, a pressure differential created within the rotating grease is sufficient to cause side flow of the base oil.

In a second example of the first embodiment, the reservoir comprises an overhanging lip, so that the volume of grease is retained in a radial direction and in an axial direction. The reservoir may be a separate part that is moulded to or adhesively fixed to the second part of the seal. To allow the movement of base oil, the reservoir further comprises channels. The channels may be grooves provided in the lip, which allow side-flow of oil out of the reservoir. The channels may also be through-holes provided in the reservoir which allow base oil to flow in a radially outward direction. In a still further embodiment, the reservoir is made of a porous material, whereby the pores in the reservoir act as channels for the base oil.

Preferably, the channels have a width of less than 1 mm, so that grease cannot escape from the reservoir via the channels. The number of channels and the size of the channels is selected depending on the volume of base oil that is advantageously supplied to the sealing contact.

In a second embodiment of a seal according to the invention, the first part of the seal is rotational. The reservoir is then suitably moulded into an elastomeric element on which the axial sealing lip is provided. The reservoir may comprise an overhanging lip and further comprise channels, as described above. Alternatively, the reservoir may be formed by a roughened retention surface on the elastomeric element. Again, the roughened retention surface preferably extends in an axial direction at an angle of less than 40 degrees relative to the rotation axis. In high speed applications, the angle is preferably less than 20 degrees.

A seal according to the invention can be used in any rotational application for sealing a gap between an outer component that is mounted coaxially around an inner component. The first part of the seal can comprise the reservoir according to the invention and can be mounted to the inner component or to the outer component, depending on which component is rotational in use. Similarly, the second part of the seal can comprise the reservoir and can be mounted to the inner component or to the outer component. As mentioned, the second part of the seal can be a slinger. The second part can also be an integral part of an assembly in which the first part is mounted. For example, in a wheel bearing unit adapted for inner ring rotation, the part having the counterface for the axial sealing lip can be a wheel mounting flange of the bearing unit. The wheel mounting flange then comprises the reservoir feature, which may be moulded on or adhesively attached. Alternatively, depending on the material of the wheel mounting flange, the reservoir feature may be cast into the flange, or machined into the flange after e.g. a metal forging process.

A seal according to the invention is provided with a grease lubricant. The grease may be provided in a cavity of the seal, in an amount greater than the volume of grease retained in the reservoir. In an advantageous development, the reservoir is specifically filled with grease, such that the retained volume of grease represents at least 80% of the total volume of grease in the seal. Since the grease in the reservoir is the main source of base oil for lubricating the sealing contact, the amount of grease used can be significantly reduced while, at the same time, seal life is extended.

Other advantages will become apparent from the following detailed description and accompanying drawings.

### BRIEF DESCRIPTION OF THE DRAWINGS

FIG. 1 is a part cross-sectional view of a conventional seal;

FIG. 2 is a part cross-sectional view of an example of a seal according to a first embodiment of the invention, in which the reservoir feature is provided in a rotational slinger component;

FIG. 3 is a part cross-sectional view of a further example of a seal according to the first embodiment;

FIG. 4 is a part cross-sectional view of an example of a seal according to a second embodiment of the invention, in which the reservoir feature is provided in a rotational lip component;

FIG. 5a is a part cross-sectional view of a further example of a seal according to the second embodiment;

FIG. 5b is a perspective view of part of the rotational lip component of FIG. 5a.

### DETAILED DESCRIPTION

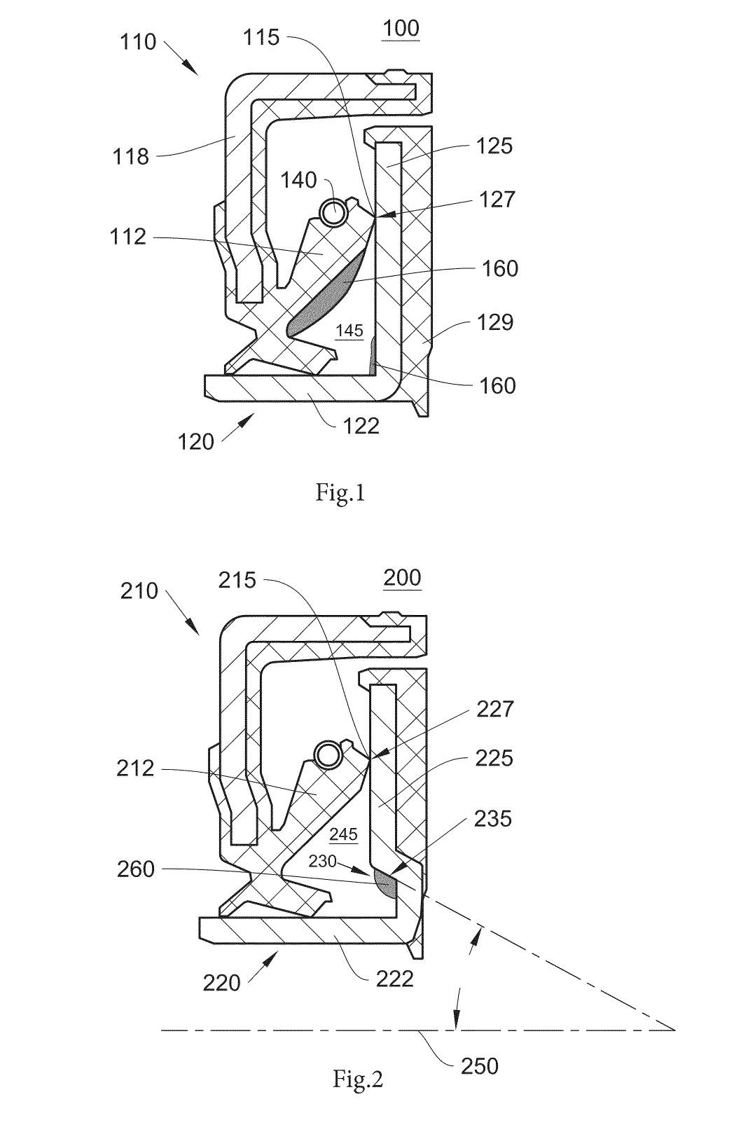

FIG. 1 shows an example of part of a conventional seal. The seal 100 has a first part 110 comprising an elastomeric element 112 bonded to a metal casing element 118. A second part 120 of the seal consists of a slinger having a radial flange part 125 and a cylindrical part 122. The elastomeric element 112 has an axial sealing lip 115, which bears against an axially inner surface 127 of the radial flange part. This axially inner surface will be referred to as an axial counterface. The elastomeric element 112 of the first part also has a radial sealing lip that bears against a radial counterface on the cylindrical part 122 of the slinger 120.

The seal shown in FIG. 1 is suitable for use in a wheel bearing unit adapted for inner ring rotation. Typically, the metal casing element 118 is mounted to a stationary outer ring of the bearing unit and the slinger 120 is mounted to a rotational inner ring. For measuring rotational speed of the inner ring, an axially outer surface of the flange part 125 of the slinger is provided with a magnetized rubber moulding 129. A changing magnetic field is picked up by e.g. a Hall sensor and the associated rotational speed data is fed to a vehicle control system such as ABS.

The main purpose of the seal is to protect the functionality of the bearing unit. The seal both retains lubricant within the bearing cavity and prevents the ingress of contaminants such as moisture and grit. The axial sealing lip 115 is particularly important for preventing the entry of contaminants and is therefore generally in tight contact with the axial counterface 127. To ensure that tight contact is maintained, the first part of the seal may further comprise a garter spring 140. Friction is therefore generated when the slinger 120 is rotating. To reduce the friction, the seal 100 is provided with a grease lubricant 160 in a cavity 145 between the axial sealing lip 115 and the cylindrical part 122 of the slinger 120.

The lubrication of the sealing contact between the axial sealing lip 115 and the axial counterface 127 will now be discussed. Under rotational conditions, most of the grease 160 will be thrown onto the stationary elastomeric element 112 and a relatively small amount of grease 160 will remain on the slinger, as indicated in FIG. 1. The grease comprises base oil held in a thickener matrix. The grease on the slinger will slowly release base oil for lubrication of the sealing contact, whereby the resulting oil flow is driven by the large centrifugal forces that result from the rotational movement. The stationary grease on the elastomeric element will also release oil, but on a much longer timescale, due to the absence of these forces.

The released oil forms an oil film under hydrodynamic lubrication conditions, which separates the axial sealing lip and the axial counterface. Over time, film thickness decreases due to loss of oil. When a feed rate of released oil becomes insufficient to replenish the sealing contact, the film thickness will reach a critical value at which the axial sealing lip and the axial counterface are no longer adequately separated. Wear and loss of sealing function will then soon take place.

The present inventor has found that the time until the critical thickness value is reached can be significantly lengthened by increasing the volume of grease on the rotating part of the seal which is available for supplying base oil to the sealing contact. As a result, seal life can be extended.

Thus, in a seal according to the invention, the rotating part of the seal comprises a reservoir feature for holding a volume of grease. The reservoir is adapted to prevent the movement of grease under the action of centrifugal force, but to allow the movement of base oil, which bleeds from the grease retained in the reservoir.

An example of a first embodiment of a seal according to the invention is shown in FIG. 2. The seal 200 is suitable for use in a wheel bearing unit adapted for inner ring rotation as described above. The seal comprises a first part 210 having an elastomeric element 212 with an axial sealing lip 215, whereby the first part 210 is identical to the first part of the seal shown in FIG. 1. The second part 220 of the seal is formed by a slinger which has a radial flange part 225 and a cylindrical part 222. A sealing contact is defined between the axial sealing lip 215 and an axial counterface 227 on the radial flange part, and the slinger rotates about a rotational axis 250. According to the invention, the slinger is provided with a reservoir 230 for retaining a volume of grease 260 at a location radially inward of the sealing contact. In this example, the reservoir 230 is formed by a bend in the flange part 225 of the slinger, such that the flange part further comprises an axially extending surface 235. This surface, which will be referred to as a retention surface, acts as an overhang for radially retaining a volume of grease 260.

In this example, the seal is filled with an amount of grease in a cavity 245 between the axial sealing lip 215 and the cylindrical part 222 of the slinger. Under the action of centrifugal force, much of the grease will be thrown onto the stationary elastomeric element 212. Some of the grease—the grease volume 260—will be thrown onto the overhanging retention surface 235 on the flange part 225 of the slinger. Suitably, the retention surface 235 extends at an angle a of less than 40 degrees relative to the rotational axis 250. In the example of FIG. 2, the angle is approximately 25 degrees. As a result, the centrifugal force acting on the grease volume 260 has a relatively small axial component, which is insufficient to allow sideways movement of the grease but which allows side flow of base oil from the grease. Upon reaching the edge of the retention surface 235, the base oil will then flow in a radially outward direction towards the sealing contact.

Comparing the inventive seal of FIG. 2 with the conventional seal of FIG. 1, it is evident that the inventive seal retains a greater volume of grease on the rotational slinger. As explained above, this leads to longer seal life.

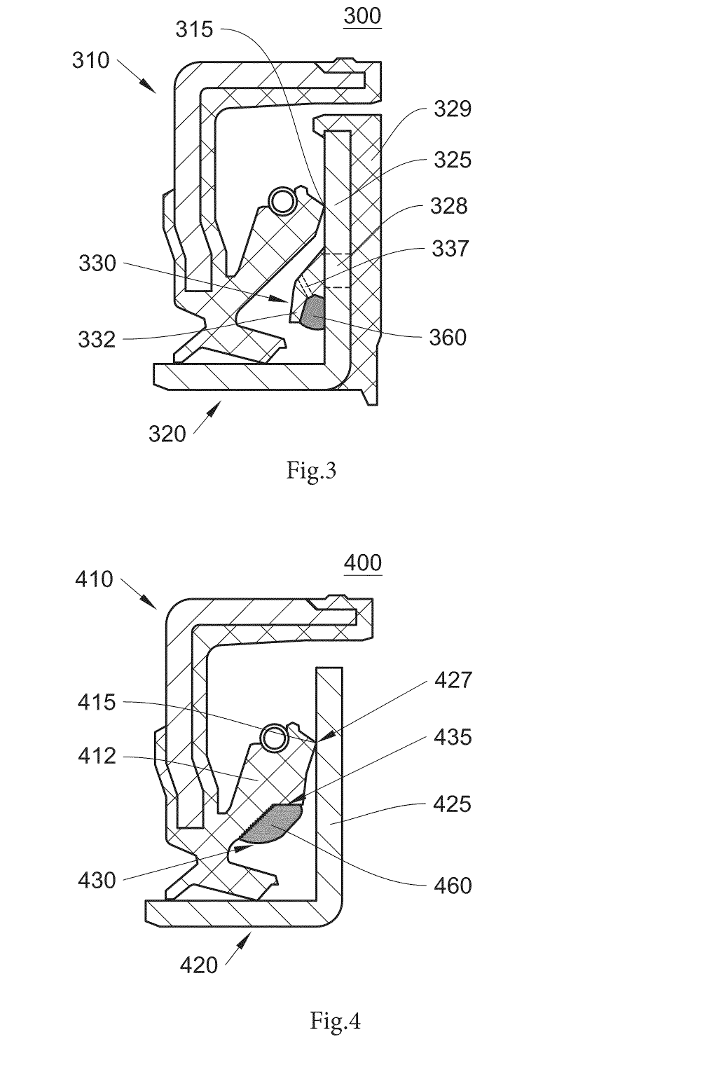

A further example of a seal according to the invention comprising a slinger with a reservoir feature is shown in FIG. 3. The seal 300 again comprises a first part 310 having an elastomeric element with an axial sealing lip 315 which is in sealing contact with a flange part 325 of the slinger 320. In this example, the reservoir 330 is formed by a moulding provided on an axially inner surface of the flange part 325. As with the example depicted in FIG. 2, the grease reservoir 330 has an overhanging surface which retains a volume of grease 360 in a radial direction. Additionally, the grease reservoir 330 comprises a lip 332 which retains the grease in an axial direction. The lip 332 also prevents the movement of base oil. Therefore, to allow base oil to move in a radially outward direction towards the sealing contact, the reservoir 330 comprises a plurality of through holes 337 which extend from a radially inner surface of the reservoir to a radially outer surface of the reservoir. Suitably, the through-holes have a diameter of less than 1 mm, so that grease from the grease volume 360 is unable to pass through.

In the example depicted in FIG. 3, the moulded grease reservoir 330 is formed as part of the process in which magnetized rubber 329 (for speed detection) is moulded to the axially outer side of the flange part 325 of the slinger. Suitably, the flange part comprises openings 328 which allow the rubber to extend to the axially inner side of the flange part 325, to form the reservoir 330. The reservoir in this example is therefore discontinuous. As will be understood, the reservoir may also be formed by a continuous part that is moulded to or adhesively fixed to the axially inner side of the flange part.

In the examples discussed thus far, the second part of the seal (the part comprising the axial counterface) has formed the rotating part of the seal. In a second embodiment, the first part of the seal forms the rotational part. A first example of such a seal according to the invention is shown in FIG. 4.

The second part of the seal 400 is again formed by a slinger 420, which has an axially oriented counterface 427 on the flange part 425. The first part 410 of the seal comprises a metal casing element to which an elastomeric element 412 is bonded. The elastomeric element has an axial sealing lip 415, which is in sealing contact with the counterface 427. Further, the elastomeric element 412 comprises a reservoir 430 according to the invention, which retains a volume of grease 460 at a location radially inward of the sealing contact. The grease volume 460 in this example is specifically provided on the reservoir 430, and constitutes the large majority of the grease within the seal.

In this example, the reservoir 430 comprises a retention surface 435 which is roughened to promote the adhesion of grease. Part of the retention surface extends in an axial direction, essentially parallel to a rotational axis of the seal. The volume of grease 460 is therefore retained in a radial direction and will not move in a sideways direction under the action of centrifugal force. A pressure differential created within the grease under rotational conditions allows the side-flow of base oil, which will ultimately flow towards the sealing contact.

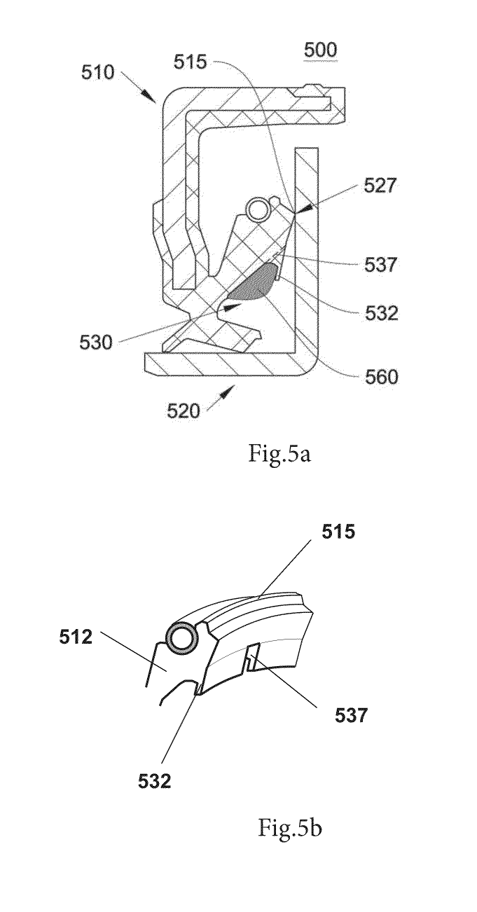

A second example of a seal according to the invention, whereby the first part of the seal 500 comprises a reservoir, is shown in FIG. 5a. In this second example, the reservoir 530 is moulded into the elastomeric element 512 of the first part 510 and comprises an overhanging lip 532. Thus, a volume of grease 560 is retained on the elastomeric element in a radial direction as well as in an axial direction. To allow the movement of base oil from the grease volume 560, the lip 532 is provided with grooves 537. A detail of the elastomeric element 512, showing the axial sealing lip 515 and the overhanging lip 532 of the grease reservoir, is depicted in FIG. 5b.

The grooves 537 extend from an axially inner side of the lip 532 to an axially outer side of the lip, thereby allowing the side flow of base oil, which will ultimately flow in a radially outward direction towards the sealing contact. Suitably, the grooves have a width of less than 1 mm, to that grease is unable to pass through.

The invention is not to be regarded as being limited to the embodiments described above, a number of additional variants and modifications being possible within the scope of the subsequent patent claims.

### REFERENCE NUMERALS

100 Conventional seal
110 First part of seal
112 Elastomeric element
115 Axial sealing lip
118 Metal casing element
120 Second part of seal (slinger)
122 Cylindrical part of slinger
125 Flange part of slinger
127 Axial counterface
129 Magnetized rubber moulding
140 Garter spring
145 Grease cavity
160 Grease
200 Seal according to invention
210 First part of seal
212 Elastomeric element
215 Axial sealing lip
120 Second part of seal (slinger)
222 Cylindrical part of slinger
225 Flange part of slinger
227 Axial counterface
230 Reservoir feature
235 Retention surface
245 Grease cavity
250 Axis of rotation
260 Grease volume in reservoir
α Angle of retention surface relative to rotation axis
300 Seal according to invention
310 First part of seal
315 Axial sealing lip
320 Second part of seal (slinger)
325 Flange part of slinger
328 Opening in flange part
329 Magnetized rubber moulding
330 Reservoir feature
332 Overhanging lip
337 Through hole
260 Grease volume in reservoir
400 Seal according to invention
410 First part of seal
412 Elastomeric element
415 Axial sealing lip
420 Second part of seal (slinger)
425 Flange part of slinger
427 Axial counterface
430 Reservoir feature
435 Roughened retention surface
460 Grease volume in reservoir
500 Seal according to invention
510 First part of seal
515 Axial sealing lip
520 Second part of seal (slinger)
527 Axial counterface
530 Reservoir feature
532 Overhanging lip
537 Groove in overhanging lip
560 Grease volume in reservoir

1. A seal comprising:
a first part, and
a second part, the first part including an axial sealing lip, the second part including an axially oriented counterface, wherein
a sealing contact is defined between the axial sealing lip and the axially oriented counterface; wherein
one of the first part and the second part rotates with respect to the other of the first part and the second part, such that the the one of the first and second parts that rotates experiences a centrifugal force; and wherein
the one of the first part and the second part that rotates is provided with a reservoir which retains a volume of grease at a location radially inward of the axial sealing lip, the reservoir being adapted to prevent the movement of grease under the action of centrifugal force but to allow the movement of base oil, bleeding from the volume of grease retained in the reservoir, towards the sealing contact.

2. The seal according to claim 1, wherein the reservoir is at least partly formed by an axially extending retention surface for retaining the volume of grease in a radial direction.

3. The seal according to claim 2, wherein the retention surface extends at an angle of less than 40 degrees relative to a rotational axis of the seal.

4. The seal according to claim 2 , wherein the retention surface extends at an angle of less than 20 degrees relative to the rotational axis (250) of the seal.

5. The seal according to claim 4, wherein the reservoir further comprises a lip for retaining the volume of grease in an axial direction, and one or more channels through which base oil can flow.

6. The seal according to claim 5, wherein the channels include through holes.

7. The seal according to claim 5, wherein the channels provide grooves in the lip of the reservoir.

8. The seal according to claim 5, wherein the reservoir is made of a porous material and the channels are formed by pores in the material,

9. The seal according to claim 8, wherein the second part of the seal is the rotating part.

10. The seal according to claim 9, wherein the reservoir is molded to or adhesively fixed to an axially inner surface of the second part.

11. The seal according to claim 9, wherein the second part is a slinger and the reservoir is formed by a bend in a radial flange part of the slinger.

12. The seal according to claim 8, wherein:
the first part of the seal rotates with respect to the second part;
the axial sealing lip is part of an elastomeric element; the reservoir is molded into the elastomeric element.

13. The seal according to claim 12, wherein the volume of grease retained in the reservoir represents at least 80% of the total grease volume within the seal.

14. An assembly comprising:
an outer component coaxially arranged around an inner component, and
a seal having a first part, and
a second part, the first part including an axial sealing lip, the second part including an axially oriented counterface, wherein
a sealing contact is defined between the axial sealing lip and the axially oriented counterface; wherein
one of the first part and the second part rotates with respect to the other of the first part and the second part, such that the one of the first and second parts that rotates experiences a centrifugal force; and wherein
the one of the first part and the second part that rotates is provided with a reservoir which retains a volume of grease at a location radially inward of the axial sealing lip, the reservoir being adapted to prevent the movement of grease under the action of centrifugal force but to allow the movement of base oil, bleeding from the volume of grease retained in the reservoir, towards the sealing contact, wherein
the first part of the seal is in connection with one of the inner component and the outer component and the second part of the seal is in connection with, or forms part of, the other of the inner component and the outer component.
